(19) United States
(12) Patent Application Publication
(10) Pub. No.: US 2011/0319226 A1
(43) Pub. Date: Dec. 29, 2011

(54) Variable Gain of a Transmission Control Element

(75) Inventors: John E. Brevick, Livonia, MI (US); Steven G. Thomas, Bloomfield Hills, MI (US); Steven A. Frait, Milan, MI (US)

(73) Assignee: FORD GLOBAL TECHNOLOGIES, LLC, Dearborn, MI (US)

(21) Appl. No.: 12/824,471

(22) Filed: Jun. 28, 2010

(51) Int. Cl. F16H 61/14

(52) U.S. Cl. 477/62

(57) ABSTRACT

A multiple gain producing device includes a control element having variable torque capacity, a source of control pressure, and a spring applying to the control element a first force due to said pressure and a variable second force opposing the control pressure, producing a first gain when control pressure is relatively low, and a second gain greater than the first gain when control pressure is relatively high.

### BACKGROUND OF THE INVENTION

1. Field of the Invention

This invention relates generally to control of friction clutches and brakes of an automatic transmission, particularly providing a range of output in responsive to a control command input.

2. Description of the Prior Art

A torque converter is a fluid coupling, which produces a hydrokinetic drive connection between an impeller, connected to a power source such as an internal combustion engine, and a turbine, connected to an input shaft of an automatic transmission. The torque converter usually includes a bypass clutch, a friction control element which alternately mechanically connects the impeller and turbine and releases the impeller to drive the impeller hydrokinetically.

The transmission produces a range of speed ratios, whose magnitude depends on the operating gear, which depends on the selective engagement and disengagement of friction clutches and brakes.

In typical electro-hydraulic control of these control elements of the torque converter and transmission, the relationship between the electrical command signal, usually current, and torque transmitting capacity of the control element is substantially linear. However, in some vehicle applications wherein an engine is capable of producing very high output torque, a linear relationship results in poor clutch resolution during light load vehicle drive conditions.

If control element gain is high while the engine is producing high output torque, during low engine torque conditions control sensitivity over the control element is low increasing the probability of transmitting torque disturbances in the driveline. Good torque converter bypass clutch control under both heavy and light torque load conditions is necessary for good performance and fuel economy.

A need exists in the industry, therefore, for a technique that provides control element sensitivity and gain enhancement for improved control over a large range of torque transmitting capacity through the control element.

### SUMMARY OF THE INVENTION

A device for multiple producing gains includes a control element having variable torque capacity, a source of control pressure, and a spring applying to the control element a first force due to said pressure and a variable second force opposing said pressure, producing a first gain when control pressure is relatively low, and a second gain greater than the first gain when control pressure is relatively high.

The multiple gain device produces torque transmitting capacity in the friction control element that is compatible with engine torque produced when a vehicle is heavily loaded or towing, yet the device produces, superior converter clutch control, resolution and gain as required under light road load conditions, without compromising fuel economy.

The device provides clutch sensitivity and gain enhancement control over a large range of torque conditions.

The assembly reduces seal drag by minimizing the number piston seals, eliminates need for a spring to release the clutch 86, and minimizes the required axial length of the assembly.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a cross section of a torque converter having multiple gain capacity;

FIG. 2 is a graph of the load-deflection relation of a Belleville spring;

FIG. 3 is a cross sectional view showing a Belleville spring arranged to transmit pressure and mechanical forces to a control element;

FIG. 4 is a cross section through a diametric plane of a torque converter control valve that produces multiple gains; and.

FIG. 5 is graph showing the relation between clutch piston actuating pressure and control pressure of the torque converter control valve of FIG. 4.

### DESCRIPTION OF THE PREFERRED EMBODIMENT

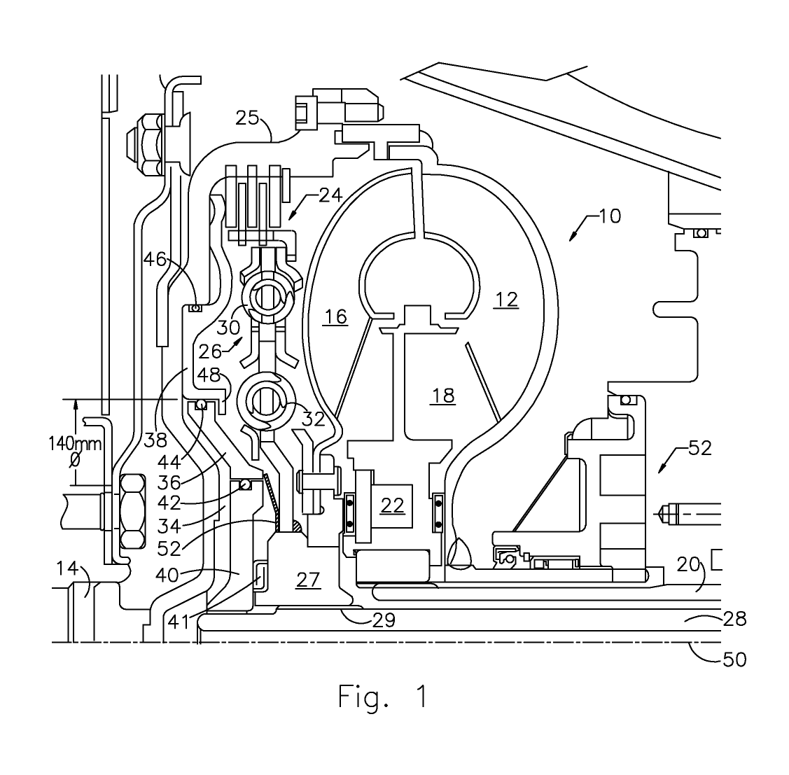

Referring first to FIG. 1, a torque converter 10 includes a bladed impeller wheel 12 connected to the crankshaft 14 of an internal combustion engine, a bladed turbine wheel 16, and a bladed stator wheel 18. The impeller, stator and turbine wheels define a toroidal fluid flow circuit, whereby the turbine is hydrokinetically driven by the impeller. The stator 18 is supported rotatably on a stationary stator sleeve shaft 20, and an overrunning brake 22 anchors the stator to shaft 20, thereby preventing rotation of the stator in a direction opposite the direction of rotation of the impeller, although free-wheeling motion in the opposite direction is permitted.

The torque converter assembly 10 includes a lockup clutch 24 located within a torque converter housing 25, which is secured to the impeller 12. The lockup clutch 24 alternately engages and disengages a drive connection between the housing 25 and a torsion damper 26. A turbine hub 27 is secured by a spline 29 to the transmission input shaft 28. Turbine torque is transmitted through the damper 26 to the transmission input shaft 28. The damper 26 may incorporate dual or single-stage compression springs 30, 32.

When lockup clutch 24 is fully engaged or slipping, i.e., while there is a speed difference between its input and output (housing 25 and input shaft 28), damper 26 attenuates transitory torque fluctuations between the engine crankshaft 14 and input shaft 28. When the clutch is disengaged, the hydrokinetic connection between impeller 12 and turbine 16 attenuates transient torque disturbances.

The lockup clutch 24 is alternately engaged and disengaged in accordance with the magnitude of clutch apply pressure in a hydraulic passage 34 communicating with a first and second pistons 36, 38. A hub 40, contacting input shaft 28 and thrust bearing 41, supports piston 36 for axial displacement on a radial outer surface of the hub. Seals 42, 44 prevent fluid leakage from passage 34 and permit axial movement of piston 36 relative to hub 40. Piston 36 supports piston 38 for axial displacement on a radial outer surface. Seals 44, 46 prevent fluid leakage from passage 34 and permit axial movement of piston 38 relative to piston 36. Piston 38 is formed with a flange 48, which extends radially inward toward a longitudinal axis 50 and over a surface of piston 36, thereby providing a blocking surface that limits independent rightward displacement of piston 36 relative to piston 38.

A Belleville spring 52 bears against piston 36 and applies a continuous force rightward displacement of piston 36 relative to piston 38. Pistons 36, 38 are closed pistons 40, sealed by O-rings 42, 44, 46.

When actuating pressure in passage 34 is low or absent, clutch 24 is disengaged, i.e., turbine 16 and impeller 12 are hydrokinetically connected and mechanically disconnected. When clutch 24 is engaged, the turbine and impeller are mechanically connected and hydrokinetically disconnected.

When the required torque transmitting capacity of lockup clutch 24 is positive but relatively low, as when the engine output torque is low, the magnitude of clutch apply pressure in hydraulic passage 34 is a relative low, whereby piston 38 is maintained at a leftward position by the force of spring 52, and the low torque piston 38 is forced by actuating pressure rightward into contact with the clutch. The pressure force on piston 38 forces the discs and plates of clutch 24 into mutual frictional contact causing the clutch to fully engage or at least partially engage.

When the magnitude of engine output torque on crankshaft 14 is high, the required torque transmitting capacity of lockup clutch 24 is high and the magnitude of clutch apply pressure in hydraulic passage 34 is a relative high. In this case, the high torque piston 38 is urged rightward by actuating pressure against the force of spring 52, forcing the low torque piston 38 rightward into contact with the clutch 24 due to contact of piston 36 against flange 48 of piston 38. The pressure force on pistons 36, 38 forces the discs and plates of clutch 24 into frictional contact causing the clutch to fully engage.

Fluid contained in the torque converter 10 is supplied from the output of an oil pump 52 and is returned to an oil sump, to which an inlet of the pump is connected hydraulically. Two other oil passages interface with the torque converter providing cooling flow (hydrodynamic and clutch). When converter clutch cooling pressure is greater than bypass clutch control pressure, this pressure returns the piston 38. The pressure that applies the clutch is the difference between the control pressure and cooling pressure. This differential pressure times the piston area minus the spring force is the resultant clutch apply force. The torque capacity can be calculated using the clutch dimensions.

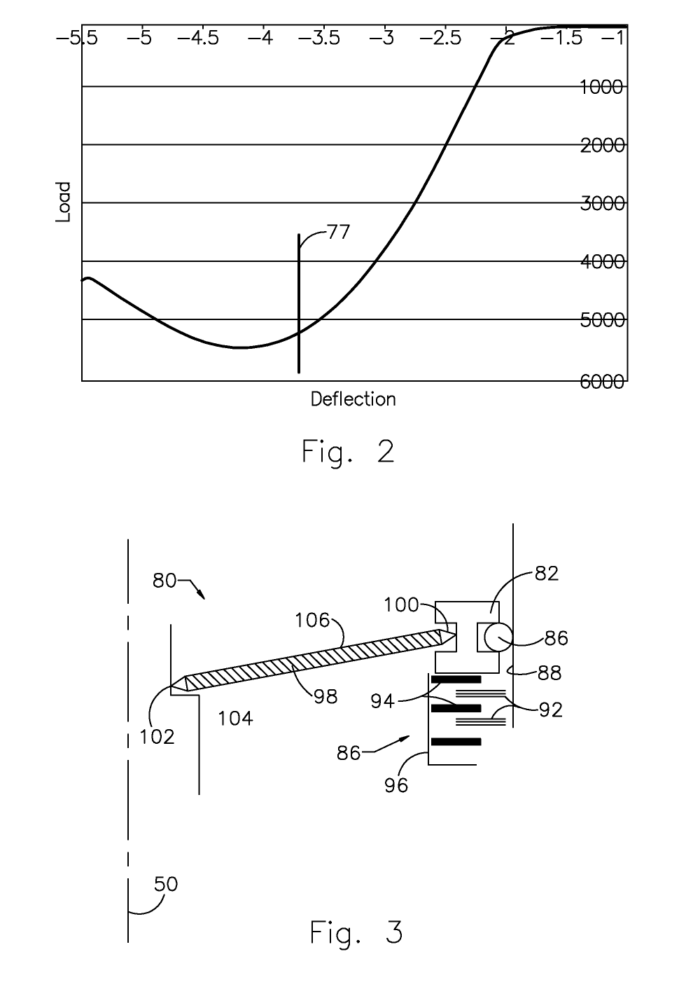

FIG. 2 is a graph showing nonlinear variation between load and deflection of a Belleville spring that would produce a dual gain when used in torque converter 10. The low load piston operating range is located at the right-hand side of the pre-load point 77, and the high load piston operating range is located at the right-hand side of point 77.

FIG. 3 illustrates a Belleville spring clutch piston assembly 80 for use in a torque converter as the high torque piston 36 of FIG. 1, or in a transmission gear shift clutch or brake, one side of the piston being vented.

In FIG. 3, a seal holder 82, supported for movement along axis 50, carries an O-ring or D-ring seal 86 along a surface 88 toward and away from a friction control element 90, such as a clutch or brake. The control element 90 includes discs 92 fitted into a spline formed on surface 88, and plates 94 fitted into a spline formed on an output member 96.

A Belleville spring 98 is fitted at its outer end with a lip seal 100 and at its inner end by a lip seal 102. The inner end of spring 98 is secured in position by contact with a shoulder 104. The outer end moves along axis 50 in response to actuating pressure 80 applied to surface 106 of spring 98. The Belleville spring 106 functions as both a spring and an actuating piston.

Actuating pressure 80 on spring 106 forces the discs and plates 92, 94 into mutual frictional contact, thereby engaging the control element 90. When actuating pressure is low, the low gain 72 is effective. When actuating pressure is high, the high gain 76 is effective.

The assembly of FIG. 3 reduces seal drag due to the presence of one rather than multiple sliding piston seals 42, 44 and 46; eliminates need for a spring to release the clutch 86; and reduces the axial length of the assembly as compared to that of the assembly of FIG. 1.

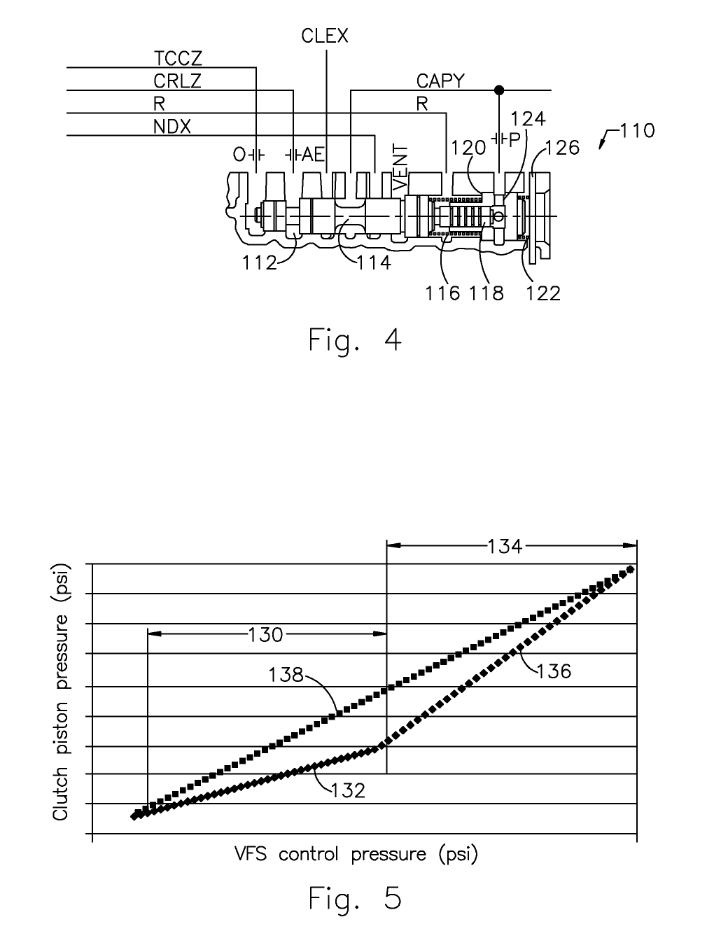

FIG. 4 shows a dual gain hydraulic control valve 110 for controlling a control element, such as torque converter clutch 24. Valve 110 includes a chamber 112, spool 114, primary compression spring 116, plunger 118, shoulder 120, secondary compression spring 122, sleeve 124, and retainer 126. Spring 116 urges spool leftward and sleeve 124 rightward. Spring 122 urges sleeve 124 leftward toward contact with shoulder 120.

TCCZ is control pressure produced by a torque converter solenoid, either a variable force solenoid or a PWM solenoid.

CLEX is output from valve 110 when the valve is exhausting. The circuit can exhaust directly to a sump, but it is preferable to use elevated vent pressure or a low pressure relief valve, such as a poppet valve, to keep the circuit filled and to avoid drain down.

CAPY is the torque converter clutch apply pressure, i.e., clutch piston pressure, or CAPY can be supplied to the clutches and brakes that produce gear shifting in a hydraulically controlled automatic transmission.

NDX is the feed to valve 110. NDX is preferably supplied from the transmission's a manual valve, which is controlled by the vehicle operator's manually control of the gear shifter. The manual valve only supplies feed in the neutral and drive positions of the gear shifter. But NDX can be directly supplied also from a source of transmission line pressure.

R is a pressure signal from the manual valve supplied when the gear shifter is moved to the reverse position. This R pressure forces CAPY to a low magnitude when the gear shifter is moved to the reverse position.

CRLZ is a pressure signal from a torque converter release circuit applied to the backside of the torque converter clutch piston. CRLZ pressure moves the regulator valve 110 a differential pressure regulator to improve performance. CRLZ pressure is preferred but can be vented in some applications.

FIG. 5 is graph showing the dual gain relation between clutch piston actuating pressure produced by the torque converter control valve of FIG. 4 in response to control pressure applied to the valve. FIG. 5 graphically illustrates two states of valve 110: a first state 130, in which sleeve 124 does not move and the valve produces a relatively low gain 132 with high resolution; and a second state 134, in which the sleeve moves proportionally to pressure, thereby producing a higher gain 136. A conventional control valve would produce a single linear gain 132.

In the low gain state 130, valve 110 functions as a pressure regulator, wherein control pressure TCCZ forces spool 114 rightward in chamber 112 against the force of spring 116. This movement opens communication between the hydraulic line that carries NDX pressure and flow to valve 110 and the line that carries CAPY pressure and flow to clutch 24. A pressure force is produced on the plunger 118 due to CAPY feedback pressure. Sleeve 124 remains in contact with shoulder 120 and does not move. In this state clutch piston pressure varies along graph 132.

As control pressure TCCZ increases, the balance of forces acting on sleeve 124, i.e., the force of spring 116 acting rightward on the sleeve, pressure force on plunger 118 acting rightward on the sleeve, and the force of spring 122 acting leftward on the sleeve, changes. When the force balance becomes equal, sleeve 124 has no force applied by shoulder 120. Therefore, any additional increase in control pressure TCCZ initiates the second state 134 and the higher gain 136.

As control pressure TCCZ increases in the second state 134, sleeve 124 shuttles rightward away from contact with shoulder 20, causing the force of spring 122 to participate in the regulation, changing the force balance of the regulating valve, and producing a larger change in CAPY pressure for a given increase in TCCZ control pressure. Gain 136 is therefore greater than gain 132 during operation in the second state.

In accordance with the provisions of the patent statutes, the preferred embodiment has been described. However, it should be noted that the alternate embodiments can be practiced otherwise than as specifically illustrated and described.

The invention claimed is:

1. A multiple gain producing device comprising:
a control element having variable torque capacity;
a source of control pressure;
a spring applying to the control element a first force due to said pressure and a variable second force opposing said pressure, producing a first gain when control pressure is relatively low, and a second gain greater than the first gain when control pressure is relatively high.

2. The device of claim 1 wherein the spring produces a knee at which a transition between the first gain and the second gain occurs when control pressure transitions past the control pressure corresponding to a location of the knee.

3. The device of claim 1, wherein the spring is a Belleville spring having a first inflected state and a second flat state and producing a nonlinear spring rate between the first and second states in response the control pressure applied to the spring.

4. The device of claim 1, further comprising:
a first seal located at an outer end of the spring; and
a second seal located at an inner end of the spring, the seals limiting leakage of fluid from the control pressure source.

5. The device of claim 1, further comprising:
member urged by the spring into contact with a first fixed surface on which the member moves along an axis;
a first seal located at an outer end of the spring, contacting the member for sealing against leakage of fluid from control pressure source past the first seal; and
a second seal located at an inner end of the spring, contacting a second fixed surface for sealing against leakage of fluid from the control pressure source past the second seal.

6. The device of claim 5, wherein the member is a seal holder further comprising;
a recess;
a third seal located in the recess, contacting the first fixed surface for sealing against leakage of fluid from control pressure source past the third seal.

7. A variable gain device comprising:
first and second pistons actuating a control element;
a source of control pressure;
a spring applying to the first piston a force continually opposing said pressure, the second piston producing a first gain in response to a relatively low magnitude of control pressure, the pistons producing a second gain greater than the first gain when a relatively high magnitude of control pressure is applied concurrently to the pistons.

8. The device of claim 7 wherein a knee is produced, at which knee a transition between the first gain and the second gain occurs when control pressure transitions past the control pressure corresponding to a location of the knee.

9. The device of claim 7 wherein the gain has a slope dependent upon a spring rate of the spring while control pressure is relatively low, and the second gain has a slope dependent upon a spring rate of the spring while control pressure is relatively high.

10. The device of claim 7 further comprising:
a torque converter including an impeller and a turbine, wherein the control element is a lockup clutch that alternately driveably connects the turbine and impeller and said connection.

11. The device of claim 7 further comprising:
a torque converter including an impeller and a turbine, wherein the control element is a lockup clutch that alternately driveably connects the turbine and impeller and said connection; and
the first piston is located radially inboard relative to the second piston, and each piston includes a pressure area on which the actuating pressure is applied.

12. The device of claim 7, wherein the spring is a Belleville spring having a first inflected state and a second flat state, wherein the spring has nonlinear spring rates in the first and second states, the spring rate in the second state being greater than the spring rate of the first state.

13. A variable gain device comprising:
a control element;
a source of control pressure;
a feed source;
a valve having a first state wherein the control element is pressurized by the feed source in response to a range of control pressure at a first gain, a second state wherein the control element is pressurized by the feed source in response to a second range of control pressure at a second gain greater than the first gain.

14. The device of claim 13, wherein the valve further comprises:
a spool whose position in a chamber communicates the feed source to the control element;
a first spring that opposes movement of the spool toward opening said communication;
a sleeve member to which a force of the first spring is applied;
a second spring that maintains the sleeve member fixed against movement in the chamber in the first state, and permits the sleeve member to apply a force of the second spring to the sleeve member, thereby opposing movement of the spool toward opening said communication.

15. The device of claim 13, wherein the valve further comprises:
a spool whose position in a chamber communicates the feed source to the control element;
a first spring that opposes movement of the spool toward opening said communication;
a plunger opposing movement of the spool toward opening said communication due to control element feedback pressure;
a sleeve member to which a force of the first spring is applied;
a second spring that maintains the sleeve member fixed against movement in the chamber in the first state, and permits the sleeve member to apply a force of the second spring to the sleeve member, thereby opposing movement of the spool toward opening said communication.
